(19) United States
(12) Patent Application Publication
(10) Pub. No.: US 2014/0149300 A1
(43) Pub. Date: May 29, 2014

(54) CONSTRUCTION INFORMATION TOOL FOR BUILDING WALLS THAT MEET BUILDING CODE REQUIREMENTS

(71) Applicant: E I DU PONT DE NEMOURS AND COMPANY, Wilmington, DE (US)

(72) Inventors: Alan Conrad Hubbell, Landenberg, PA (US); Merle Gordon Mccartney, Newark, DE (US)

(73) Assignee: E I DU PONT DE NEMOURS AND COMPANY, Wilmington, DE (US)

(21) Appl. No.: 14/066,080

(22) Filed: Oct. 29, 2013

Related U.S. Application Data
(60) Provisional application No. 61/730,146, filed on Nov. 27, 2012.

(51) Int. Cl. G06Q 30/00

(52) U.S. Cl. CPC G06Q 30/018
USPC 705/317

(57) ABSTRACT

A system gathers user data from a user, analyzes the user data to identify material requirements and construction methods to construct walls in a way that meets building code requirements.

### FIELD OF THE INVENTION

The invention described herein relates generally to a tool that provides detailed construction information on how to build walls in a way that meets building code requirements.

### BACKGROUND OF THE INVENTION

When building walls for building construction, a construction professional, such as a builder, contractor or architect, is challenged with determining the specific building and energy code requirements. The requirements are specific to the building and are dependent on the climatic conditions that prevail in the geographical region where the walls will be built (“climate zone”), the type of cladding being used, and the specific code or codes that are in force in the state or local governmental region. Additionally, some state or local governmental entities institute their own building code, but reference a different code for the energy requirements portion of the building code. These energy requirements are “overlayed” on the building code and specify the thermal requirements and the air tightness requirements for the home and/or building envelope.

For residential construction, the International Residential Code (IRC) is the National Model Building Code. The National Model Building Code for commercial construction is the International Building Code (IBC). The IBC contains a residential portion and a commercial portion. The IECC (International Energy Conservation Code) is the National Model Energy Code. These building and energy codes are revised and updated in three (3) year increments. However, state or local governmental entities may choose not to update their building codes on that same cycle. The updates will necessitate that a construction professional routinely research new building and energy codes.

Optionally, some construction professionals choose to build above the minimum standards of a code and achieve certification under a program which has stricter requirements than the codes required by a state or local governmental entity. Understanding the specific program requirements and the relationship to code requirements can also be a challenging task. Given the number of codes, updates every 3 years, the possibility to overlay optional energy codes (also updated every 3 years), the number of climate zones, the variety of cladding types, and the option to build beyond code to a certification program, the number of possible combinations and unique requirements are numerous and difficult to manage. There is a need for a tool to identify the building code requirements for unique and specific situations.

Additionally, once the specific building code requirements are understood, a construction professional must then determine solutions for how to build in a way that meets or exceeds the requirements for the specific situation at hand. A building envelope is comprised of various components that help meet or exceed the building and energy code requirements. Such components include wall studs, cavity insulation, exterior insulation, water-resistive barrier, air barrier, vapor retarder, and cladding. These components can be selected and assembled in a variety of ways to meet the requirements. A number of solutions may exist to combine the components in a manner that meet the same code requirement. There is a need for a tool that provides detailed construction information on how to build walls in a way that meets building code requirements.

### SUMMARY OF THE INVENTION

The construction information tool of the present invention provides detailed construction information on how to build walls in a way that meets building code requirements, comprising a means to input choice of building code, choice of cladding type, and climatic zone; a database of building codes; an algorithm selects the appropriate requirement set from the database as specified from the user-selected inputs; and a means to output the optimal construction information.

The construction information tool eliminates the tedious process of manually reviewing building and energy codes to ascertain the specific weatherization frame wall requirements for construction in a given geographic area, by cladding type.

The construction information tool allows the user to generate a customized report of code requirements and recommended building instructions for a given climate zone, building code, and facade cladding type. Original code requirements are reorganized by the tool into thermal, moisture, and air sections. The tool seamlessly integrates optional energy code or certification requirements into the results if selected by the user. Separate instruction sets are automatically generated for each insulation rating (R-factor) specified by the building or energy code. The instruction sets are specific to the selected inputs specified by the user.

Users may generate a downloadable and printable report of the combined weatherization requirements and building instructions, or may save their results within the tool for quick retrieval at a later date.

### DEFINITIONS

The term “climate zone ” is used herein to refer to geographic regions defined in climate classification systems as a means to map regions of like climate. ASHRAE Standard 169, Climatic Data for Building Design Standards, is an example of a climate classification system with defined climate zones.

The term “building code” is used herein to refer to a series of ordinances enacted by a state or local governmental entity, establishing minimum requirements that must be met in the construction and maintenance of buildings.

The term “energy code” is used herein to refer various energy standards for residential and commercial buildings which set a minimum level of energy efficiency at the time of new construction or renovation.

The term “certifications” is used herein to refer to a written declaration that a particular product or service complies with stated criteria.

The term “The International Residential Code (IRC)” is used herein to refer to a comprehensive, stand-alone residential code that creates minimum regulations for one- and two-family dwellings of three stories or less. It brings together all building, plumbing, mechanical, fuel gas, energy and electrical provisions for one- and two-family residences. The IRC is codified and published by The International Code Council (ICC).

The term “International Energy Conservation Code (IECC)” is used herein to refer to a code which encourages energy conservation through efficiency in envelope design, mechanical systems, lighting systems and the use of new materials and techniques. The IECC is codified and published by The International Code Council (ICC).

The term “building envelope” is used herein to refer to a system or assembly of exterior wall components, including exterior wall finish materials, that provide protection of the building structural members, including framing and sheathing materials, and conditioned interior space, from the detrimental effects of the exterior environment.

The term “cladding” is used herein to refer to any material that constitutes the exposed, non-load bearing, exterior covering of an exterior wall. Such material is applied over any sheathing that is present, or otherwise is directly attached to the building envelope as the outermost component of the wall system.

The term “wall studs” is used herein to refer to the any of the stick-like parts that form the vertical structural framework of a wall. Wall studs may be load-bearing or nonload-bearing.

The term “cavity” is used herein to refer to any air space, which is either wholly or substantially unobstructed in the building envelope. Typical cavities exist between wall studs and between the weather-resistive barrier and the back surface of the cladding.

The term “cavity insulation” is used herein to refer to any thermally insulating material located in a cavity.

The term “water-resistive barrier” is used herein to refer to a material that is intended to resist liquid water that has penetrated behind the cladding from further intruding into the exterior wall assembly. The water-resistive barrier is placed on the interior side of the cladding.

The term “air barrier” is used herein to refer to any material or combination of materials and assemblies that restrict or prevent the passage of air through the building thermal envelope

The term “vapor retarder” is used herein to refer to any material (membrane or paint) that has a water vapor permeance (perm) rating of 57 ng/(Pasm2) (1 perm) or less.

The term “Exterior Insulation and Finishing System (EIFS)” is used herein to refer to any nonload-bearing, exterior cladding that consists of a rigid insulation board attached either adhesively or mechanically, or both, to the substrate; an integrally reinforced base coat; and a textured protective finish coat.

The term “exterior insulation” is used herein to refer to any rigid insulation board used as a component of Exterior Insulation and Finishing System (EIFS).

The term “lookup function” is used herein to refer to software tools that return a value from a table by looking up another value in the table.

The term “ IF, THEN logic” is used herein to refer to any software tool that implements if A, then B conditional logic.

### BRIEF DESCRIPTION OF THE DRAWINGS

FIG. 1 is a block diagram of system architecture between inputs and outputs.

FIG. 2A is a flowchart illustrating the algotithim to provide detailed user construction information on how to build walls from user supplied input.

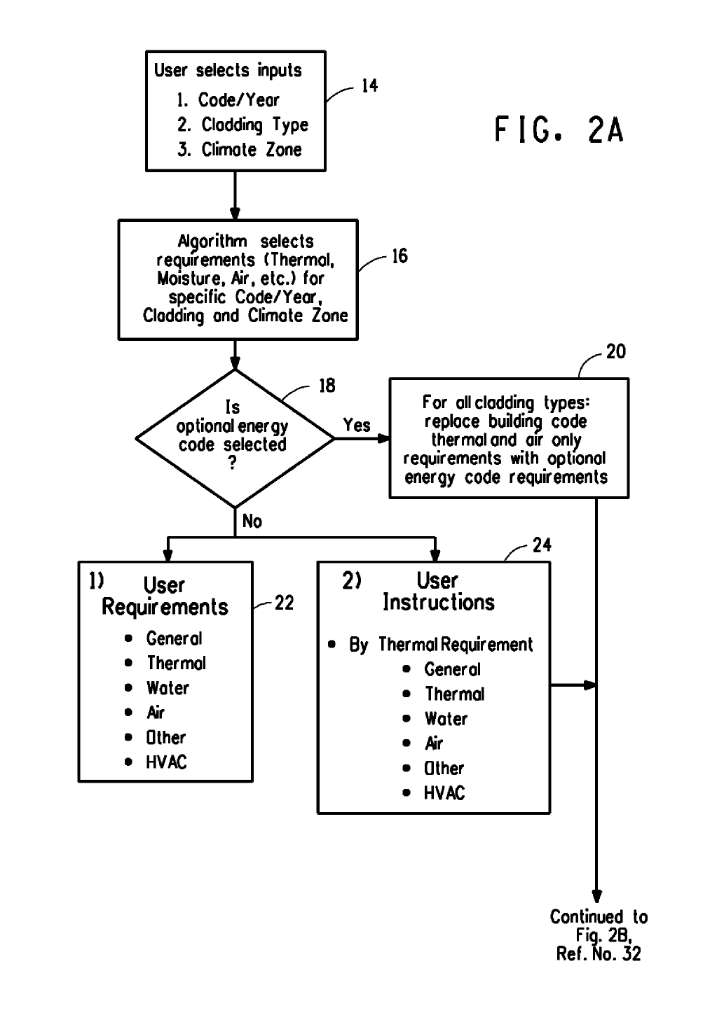

FIG. 2B is a continuation of the flowchart of FIG. 2A illustrating the algorithim to overlay optional energy requirements.

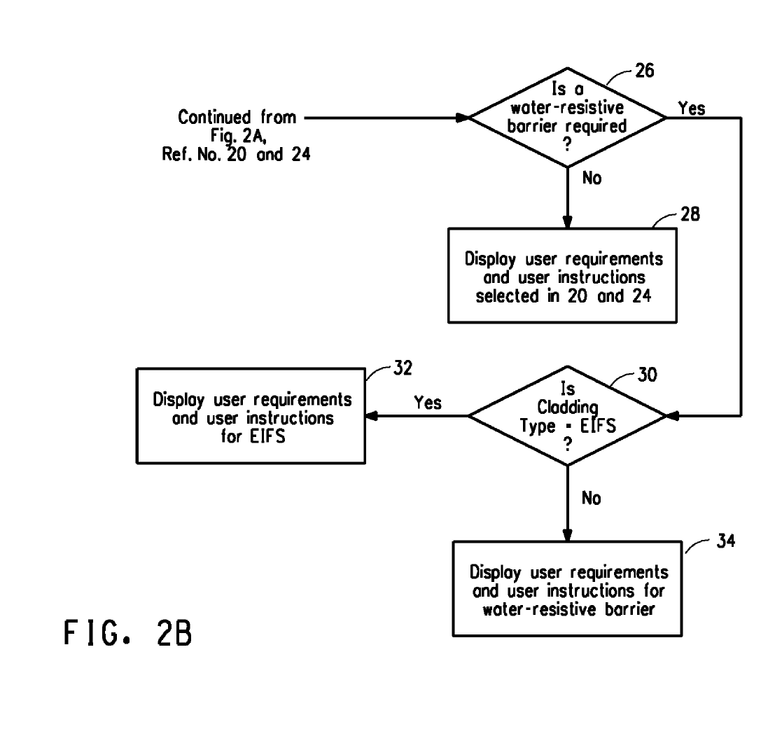

### DETAILED DESCRIPTION

In the following description, for the purposes of explanation, numerous specific details are set forth in order to provide a thorough understanding of the present disclosure. It will be apparent, however, to one skilled in the art that the present disclosure may be practiced without these specific details. In other instances, well-known structures and devices are shown in block diagram form in order to avoid unnecessarily obscuring the present disclosure.

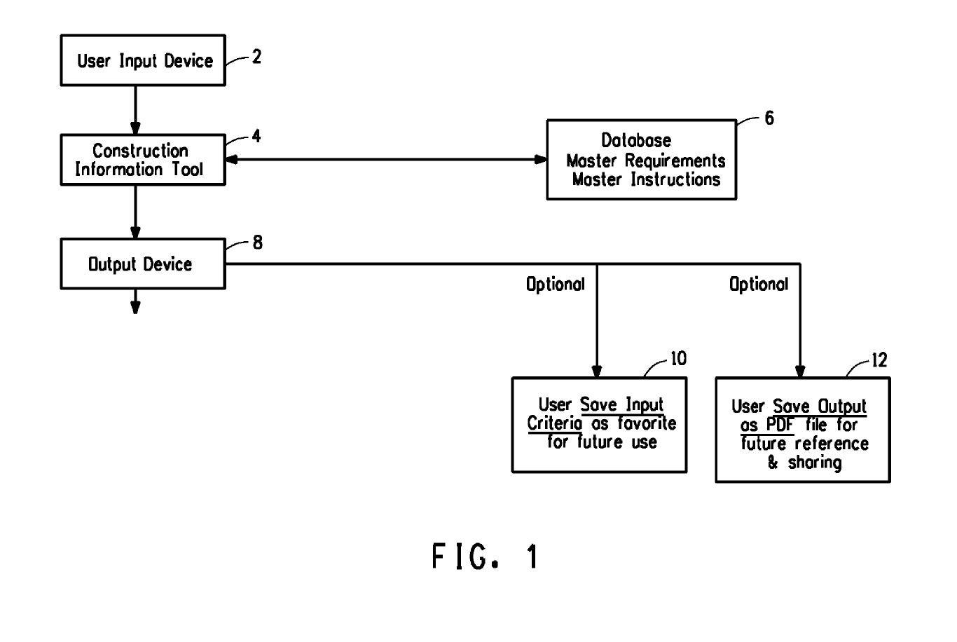

FIG. 1 is a block diagram showing system architecture of an exemplary construction information tool according this disclosure for detailed construction information on how to build walls in a way that meets building code requirements. Referring to FIG. 1, user input device 2 are connected to, and in communication with, an expert construction information tool 4 via a data transmission network. The expert construction information tool 4 may be implemented in a data processing system, such as a server. Outputs are sent to an output device 8, and preferably are returned via the same data transmission network and displayed on the same device which was used to input information.

Users may use any electronic means to input their choice of building code, choice of cladding type, climatic zone in which the walls are to be built, and any optional information to the construction information tool 4. The user preferably uses any one of a number of standard web browsers such as Firefox, a product of Mozilla Corporation, Mountain View, Calif.; or Internet Explorer, a product of Microsoft Corporation, Redmond, Wash., and the construction information tool is preferably compliant with a variety of web browsers.

A database 6, is in communication with construction information tool 4. The database 6 contains master requirement data on building codes, cladding, and climate zones. Database 6 also contains master construction instruction data, with specific code language from various building codes, energy codes, and certification programs. For example, the 2006 IRC requirements for brick cladding in Climate Zone 4 of the United States of America are listed in a table and organized according to the thermal requirements, moisture requirements , and air requirements. Similarly the 2006 IECC requirements for brick cladding in Climate Zone 4 are also included and organized in the same fashion.

Each individual set of user inputs 14 generates a unique set of user requirements 22. User requirements for various sets of user inputs may point to similar requirement sets. Thus, the number of unique requirement sets is less than the possible number of unique input sets, i.e. various user building situations may result in identical requirements.

Construction information tool 4 employs an algorithm for selecting user requirements 22 and user instructions 24 through IF, THEN logic and a lookup function. The construction information tool 4 selects the appropriate user requirement 22 set from database 6 as specified from the user-selected inputs 14 and displays the user requirements 22 and user instructions 24 using output means 10.

### Algorithm:

| User Requirements Lookup: | |
|---|---|
| IF (selected cladding type = EIFs) THEN | |
| A) | Retrieve requirements where |
| | barrier type NOT = “MOISTURE” |
| | and climate zone = (user input) |
| | and cladding = (“ALL” or EIFs) |
| | and building code = (user input) |
| | and IF (user supplied energy code) THEN energy code = (user |
| input) | |
| | and IF (user supplied energy certification) THEN energy |
| certification = (user input) | |
| B) | Retrieve and Append requirements where |
| | barrier type = “MOISTURE” |
| | and climate zone = (user input) |
| | and cladding = EIFs |
| | and building code = (user input) |
| | and IF (user supplied energy code) THEN energy code = (user |

input)

and IF (user supplied energy certification) THEN energy

certification = (user input)
ELSE
Retrieve requirements where

climate zone = (user input)
and cladding = (“ALL” or user input)
and building code = (user input)
and IF (user supplied energy code) THEN energy code = (user

input)

and IF (user supplied energy certification) THEN energy

certification = (user input)
User Instructions Lookup:
Retrieve instructions where

climate zone = (user input)
and cladding = (“ALL” or user input)
and building code = (user input)
and IF (user supplied energy code) THEN energy code = (user

input)

and IF (user supplied energy certification) THEN energy

certification = (user input)

If the user selects an optional energy code 18, the algorithim replaces 20 the thermal and air sections of the chosen building code with the selected optional requirements. The moisture requirements are not replaced. However, the replacement of thermal and air requirements based on selecting an optional energy code does not apply when EIFS is the selected cladding 30 type input. If EIFS 30 is chosen, all requirements are replaced with the EIFS requirements.

To use the construction information tool 4 a user must input one climate zone from a list of available climate zones. Illustratively, a list may be displayed in a drop down window. The user must also input one building or energy code from a list of available building codes. Ilustratively, a list may be displayed in a drop down window. The user must input a type of cladding to be used in the building envelope. Illustratively, a list may be displayed in a drop down window. Optionally, the user may also select a certification program. Energy Star is an example of an optional certification program. Illustratively, a list may be displayed in a drop down window. The user inputs are communicated to the construction information tool 4, which generates the requirments for walls, and instructions for building the walls, and outputs the requirements and instructions to the output means. Optionally, the user inputs and associated output may be saved for future use.

What is claimed is:

1. A construction information tool that provides detailed construction information on how to build walls in a way that meets building code requirements, comprising:
a) means to input choice of building code, choice of cladding type, and climatic zone; and
b) a database of building codes; and
c) an algorithm for selecting materials and construction instructions from the database through IF, THEN logic and a lookup function, and
d) means to output the requirements and construction information.
